(19) United States
(12) Patent Application Publication
(10) Pub. No.: US 2013/0288940 A1
(43) Pub. Date: Oct. 31, 2013

(54) PERFUME COMPOSITION COMPRISING FRAGRANCE ALDEHYDE OR KETONE AND OXAZOLIDINE FRAGRANCE PRECURSOR

(71) Applicant: Henkel AG & Co. KGaA, Duesseldorf (DE)

(72) Inventors: Ursula Huchel, Koeln (DE); Andreas Bauer, Kaarst (DE); Ralf Bunn, Duesseldorf (DE); Hubert Smyrek, Krefeld (DE); Manuela Manterne, Kaarst (DE); Frank Rittler, Duesseldorf (DE)

(21) Appl. No.: 13/922,448

(22) Filed: Jun. 20, 2013

Related U.S. Application Data
(63) Continuation of application No. PCT/EP2011/068050, filed on Oct. 17, 2011.

(30) Foreign Application Priority Data
Dec. 21, 2010 (DE) 10 2010 063 693.2

(51) Int. Cl. C11D 3/50

(52) U.S. Cl. CPC C11D 3/50
USPC 510/103; 512/10

(57) ABSTRACT

The invention relates to perfume compositions encompassing fragrance aldehyde or fragrance ketone, and to an oxazolidine fragrance precursor, corresponding thereto, that can release the same fragrance aldehyde or the same fragrance ketone. The perfume compositions can be incorporated in stable fashion into consumer products such as, for example, washing agents, and enable both efficient product scenting and long-lasting item scenting, in particular of textiles.

### FIELD OF THE INVENTION

The present invention generally relates to special perfume compositions. It further relates to consumer products, such as in particular washing or cleaning agents, cosmetics, or adhesives, that contain such perfume compositions. It further relates to a method for scenting textiles.

### BACKGROUND OF THE INVENTION

The procedure for perfuming consumer products is generally such that a perfume oil containing fragrances is mixed directly with the target product, such as e.g., a washing agent. It can be problematic in this connection that volatile fragrances can be partly lost by vaporization, already during incorporation into the product or during storage. Numerous fragrances, such as in particular aldehydes, are also unstable under particular conditions, so that partial or complete decomposition of fragrances can occur. The corresponding substances are then in part only slightly perceptible, or not all, in the final product. This can result, for example, in a change in the overall odor impression of the composition. A need to protect fragrances therefore exists. A need additionally exists to obtain a scent effect that is as long-lasting as possible, for example with regard to washing and cleaning operations. The existing art describes fragrance precursors for this purpose.

German examined application DE 1 133 847 describes the use in perfumery of condensation products of aldehydes and ketones with oxyamines instead of the free aldehydes and ketones. The aldehydes and ketones are reacted with ethanolamine or diethanolamine for that purpose. U.S. Pat. No. 6,861,402 describes fragrance precursors that contain a fragrance aldehyde or fragrance ketone in the form of an oxazolidine; here N-benzylethanolamine, for example, is reacted with a fragrance so as to produce a monocyclic oxazolidine. US 2003/0207786 A1 likewise describes fragrance precursors that have an oxazolidine structure. U.S. Pat. No. 4,277,353 describes mono- and bicyclic oxazolidines as corrosion-inhibiting additives for lubricating oils. US 2004/0087453 A1 describes specific photolabile fragrance precursors that can also be bound in the form of oxazolidines. US 2004/0067870 A1 describes special fragrance aldehydes having a tertiary alpha-carbon atom, which can also be bound in the form of oxazolidines. US 2003/0158079 A1 describes active substance discharge systems suitable for discharging an active substance onto a substrate, the active substance discharge system encompassing an active substance in the form of an aldehyde or ketone, and an amine that encompasses a primary and/or secondary amine unit. WO 2007/087977 A1 relates to 1-aza-3,7-dioxabicyclo[3.3.0]octane compounds whose use results in a prolonged scent impression of fragrance aldehydes and fragrance ketones. The teaching to use specific mixtures of 1-aza-3,7-dioxabicyclo[3.3.0]octane compounds and aldehydes or ketones in perfume compositions cannot, however, be directly and unequivocally gathered from WO 2007/087977.

The object of the present invention was to make available a perfume composition that enables both good product scenting (e.g., of a washing agent) and a long-lasting scent effect.

Furthermore, other desirable features and characteristics of the present invention will become apparent from the subsequent detailed description of the invention and the appended claims, taken in conjunction with this background of the invention.

### BRIEF SUMMARY OF THE INVENTION

In an embodiment, a perfume composition comprises: (a) at least one fragrance aldehyde having at least 6 carbon atoms or a fragrance ketone having at least 6 carbon atoms, and (b) at least one oxazolidine fragrance precursor, corresponding to the fragrance aldehyde or fragrance ketone recited under (a), that can release the same fragrance aldehyde or the same fragrance ketone, where the oxazolidine fragrance precursor is a 1-aza-3,7-dioxabicyclo[3.3.0]octane compound of the general formula (I)

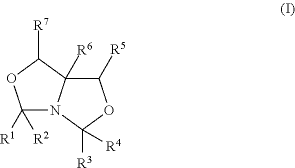

where R¹, R², R³, R⁴ mutually independently denote residues that, in a compound having the general formula R¹—C(═O)—R² or R³—C(═O)—R⁴, yield a fragrance aldehyde having at least 6 carbon atoms or a fragrance ketone having at least 6 carbon atoms, and R⁵, R⁶, R⁷ mutually independently denote hydrogen or a hydrocarbon residue that can be acyclic or cyclic, substituted or unsubstituted, branched or unbranched, and saturated or unsaturated.

In an embodiment, a method for scenting textiles comprises: subjecting the textiles to a washing process utilizing a composition comprising (a) at least one fragrance aldehyde having at least 6 carbon atoms or a fragrance ketone having at least 6 carbon atoms, and (b) at least one oxazolidine fragrance precursor, corresponding to the fragrance aldehyde or fragrance ketone recited under (a), that can release the same fragrance aldehyde or the same fragrance ketone, where the oxazolidine fragrance precursor is a 1-aza-3,7-dioxabicyclo[3.3.0]octane compound of the general formula (I)

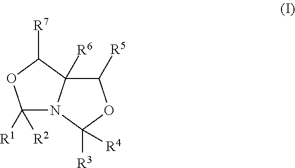

where R¹, R², R³, R⁴ mutually independently denote residues that, in a compound having the general formula R^{1—C(═O)—R}² or R³—C(═O)—R⁴, yield a fragrance aldehyde having at least 6 carbon atoms or a fragrance ketone having at least 6 carbon atoms, and R⁵, R⁶, R⁷ mutually independently denote hydrogen or a hydrocarbon residue that can be acyclic or cyclic, substituted or unsubstituted, branched or unbranched, and saturated or unsaturated.

In an embodiment, a method for scenting textiles comprises: subjecting the textiles to a washing process utilizing a washing or cleaning agent comprising (a) at least one fragrance aldehyde having at least 6 carbon atoms or a fragrance ketone having at least 6 carbon atoms, and (b) at least one oxazolidine fragrance precursor, corresponding to the fragrance aldehyde or fragrance ketone recited under (a), that can release the same fragrance aldehyde or the same fragrance ketone, where the oxazolidine fragrance precursor is a 1-aza-3,7-dioxabicyclo[3.3.0]octane compound of the general formula (I)

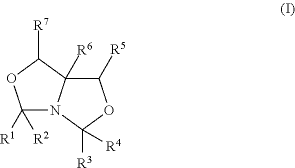

where R¹, R², R³, R⁴ mutually independently denote residues that, in a compound having the general formula R¹13 C(═O)—R² or R³—C(═O)—R⁴, yield a fragrance aldehyde having at least 6 carbon atoms or a fragrance ketone having at least 6 carbon atoms, and R⁵, R⁶, R⁷ mutually independently denote hydrogen or a hydrocarbon residue that can be acyclic or cyclic, substituted or unsubstituted, branched or unbranched, and saturated or unsaturated, and wherein the composition is present in quantities from 0.0001 to 15 wt %, based on the total agent.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The object of the present invention is achieved by the subject matter of the invention. The subject matter of the present invention is a perfume composition encompassing
(a) at least one fragrance aldehyde having at least 6, by preference at least 7, in particular at least 8 carbon atoms, or a fragrance ketone having at least 6, by preference at least 7, in particular at least 8 carbon atoms, and
(b) at least one oxazolidine fragrance precursor, corresponding to the fragrance aldehyde or fragrance ketone recited under (a), that can release the same fragrance aldehyde or the same fragrance ketone,
   where the oxazolidine fragrance precursor is a 1-aza-3,7-dioxabicyclo[3.3.0]octane compound of the general formula (I)

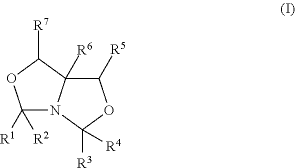

where
R¹, R², R³, R⁴ mutually independently denote residues that, in a compound having the general formula R¹—C(═O)—R² or R³—C(═O)—R⁴, yield a fragrance aldehyde having at least 6, by preference at least 7, in particular at least 8 carbon atoms, or a fragrance ketone having at least 6, by preference at least 7, in particular at least 8 carbon atoms,
R⁵, R⁶, R⁷ mutually independently denote hydrogen or a hydrocarbon residue that can be acyclic or cyclic, substituted or unsubstituted, branched or unbranched, and saturated or unsaturated.

The perfume composition according to the present invention thus contains mixtures of free fragrance aldehyde and/or fragrance ketone having at least 6 carbon atoms, and the corresponding oxazolidine in which the same fragrance aldehyde and/or fragrance ketone is present in bound form.

It has been found, surprisingly, that such perfume compositions make possible particularly good and efficient scenting of usual consumer products, such as in particular washing or cleaning agents, cosmetics, adhesives. It is possible, with the aid of the perfume compositions according to the present invention, to generate in particular a fresh scent impression that also lasts a long time. In addition, incorporation of the perfume compositions disclosed herein into usual consumer products results in very stable products. The products, for example washing agents, are particularly shelf-stable even under more-critical conditions such as, for example, at elevated temperatures such as those that can occur, for example, in tropical and subtropical climates. These advantages have been ascertained for both solid and liquid products, such as in particular washing or cleaning agents, for example fabric softeners. It has furthermore been found, surprisingly, that the perfume compositions according to the present invention enable particularly good and long-lasting item scenting when the correspondingly perfumed consumer products are used, for example in the context of washing or cleaning operations. A particularly long-lasting scent on dried laundry was found in particular in this connection.

All hydrocarbon residues for purposes of the present invention can in principle be acyclic or cyclic, substituted or unsubstituted, branched or unbranched, and saturated or unsaturated. The hydrocarbon residues for purposes of the invention can in principle encompass heteroatoms such as, for example, nitrogen, oxygen, or sulfur atoms. Acyclic, unbranched hydrocarbon residues that optionally can be substituted are respectively preferred with regard to R⁵, R⁶, and R⁷. Suitable substituents are, for example, hydroxy, alkoxy, amino, or halogen groups.

By preference, residues R¹ and R² or R³ and R⁴ that yield a fragrance ketone in a compound of the general formula R¹—C(═O)—R² or R³—C(═O)—R⁴ are present at most in one of the structural elements —CR¹R² or —CR³R⁴. In particular, residues R¹ and R² or R³ and R⁴ that each yield a fragrance aldehyde, in particular the same fragrance aldehyde, in a compound of the general formula R¹—C(═O)—R² or R³—C(═O)—R⁴ are present in both structural elements —CR¹R² or —CR³R⁴.

R⁵ and R⁷ each, mutually independently, advantageously denote hydrogen or a C₁₋₆ hydrocarbon residue that optionally can be substituted, by preference a C₁₋₃ hydrocarbon residue. Particularly preferably, R⁵ and R⁷ are each hydrogen or each a methyl or ethyl residue, but in particular are each hydrogen.

R¹ and R³ each, mutually independently, advantageously denote a C₆₋₂₄ hydrocarbon residue, by preference a C₇₋₂₄ hydrocarbon residue, where the hydrocarbon residue can be acyclic or cyclic, substituted or unsubstituted, branched or unbranched, and saturated or unsaturated.

In a further preferred embodiment, R², R⁴, R⁵, R⁷ signify hydrogen, R¹ and R³ each signify a C₆₋₂₄ hydrocarbon residue, by preference a C₇₋₂₄ hydrocarbon residue, where the hydrocarbon residue can be acyclic or cyclic, substituted or unsubstituted, branched or unbranched, and saturated or unsaturated, and R⁶ denotes hydrogen or a C₁₋₂₄ hydrocarbon residue that can be acyclic or cyclic, substituted or unsubstituted, branched or unbranched, and saturated or unsaturated, and that can be substituted in particular with one or two hydroxyl groups and/or an amino group, where as many as 8 non-adjacent —CH₂ groups can also be replaced by —O—.

With reference to R⁶, preferred residues are C₁₋₁₆ hydrocarbon residues, in particular C₁₋₁₂ hydrocarbon residues, more preferably C₁₋₆ hydrocarbon residues, most preferably C₁₋₃ hydrocarbon residues. These are by preference unbranched, acyclic alkyl residues. They can also be substituted. These can be, for example, mono- or dihydroxyalkyl residues that can also have an amino group instead of the hydroxyl groups or in addition to the hydroxyl groups. If the hydrocarbon residues are interrupted by —O—, the structural elements are preferably those of the formula —CH₂—CH₂—O— or —CH₂CH(CH₃)—O—. Such compounds are easily accessible by alkoxylation of the corresponding hydroxy compounds. Very particularly preferred residues R⁶ are methyl, ethyl, or hydroxymethyl residues, or hydrogen.

In a very particularly preferred embodiment, the residues R², R⁴, R⁵, R⁷ accordingly each signify hydrogen, and the residue R⁶ signifies a methyl, ethyl, or hydroxymethyl residue or hydrogen. The residues R¹ and R³ each preferably signify a C₆₋₂₄ hydrocarbon residue, in particular a C₇₋₂₄ hydrocarbon residue, where the hydrocarbon residue can be acyclic or cyclic, substituted or unsubstituted, branched or unbranched, and saturated or unsaturated.

Suitable oxazolidine fragrance precursors according to the general formula (I) are accordingly, for example, 1-aza-3,7-dioxa-2,8-diheptylbicyclo[3.3.O]o ctane, 1 -aza-3,7-dioxa-2,8-diheptyl-5-methylbicyclo[3.3.0]octane, 1-aza-3,7-dioxa-2,8-diheptyl-5-hydroxymethylbicyclo[3.3.0]octane, 1-aza-3,7-dioxa-2,8-diheptyl-5-ethylbicyclo[3.3.0]octane, 1-aza-3,7-dioxa-2,8 -dioctylbicyclo[3.3.0]octane, 1-aza-3,7-dioxa-2,8-dioctyl-5-methylbicyclo[3.3.0]octane, 1-aza-3,7-dioxa-2,8-dioctyl-5-hydroxymethylbicyclo[3.3.0] octane, and 1-aza-3,7-dioxa-2,8-dioctyl-5 -ethylbicyclo[3.3.0]octane.

The compounds of the general formula (I) usable according to the present invention are obtainable in particular by reacting compounds of the general formula (II)

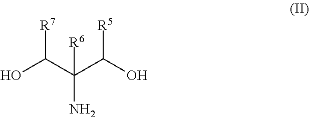

with compounds of the general formulas R¹—C(═O)—R² and R³—C(═O)—R⁴, accompanied by ring closure. A suitable substance in accordance with formula (II) is, for example, 2-aminopropane-1,3-diol. The descriptions already given above apply to the residues R¹ to R⁶. For purposes of the invention, the general formulas R¹—C(═O)—R² and R³—C(═O)—R⁴ very generally represent fragrance aldehydes or fragrance ketones. Fragrance aldehydes are those fragrances that are chemically an aldehyde and that advantageously stimulate in humans an, in particular, pleasant odor sensation. Fragrance ketones are those fragrances that are chemically a ketone and that advantageously stimulate in humans an, in particular, pleasant odor sensation. Particularly suitable fragrance aldehydes and fragrance ketones are listed by way of example below. Two examples will be given for illustration. In the case of the fragrance aldehyde octanal, in accordance with the general formula R¹—C(═O)—R² the residue R¹ denotes a heptyl residue (i.e. CH₃—(CH₂)₆—) and the residue R² denotes hydrogen, or vice versa. In the case of the fragrance ketone methyl nonyl ketone, for example, in accordance with the general formula R¹—C(═O)—R² the residue R¹ denotes a methyl residue and the residue R² denotes a nonyl residue (i.e. CH₃—(CH₂)₈—), or vice versa.

All usual fragrance aldehydes and/or fragrance ketones that are utilized in particular to bring about a pleasant odor sensation in humans can be used, in principle, as fragrance aldehydes and/or fragrance ketones. Such fragrance aldehydes and/or fragrance ketones are known to one skilled in the art and are also described in the patent literature, for example in US 2003/0158079 A1, Paragraphs [0154] and [0155].

Particularly preferred fragrance aldehydes usable for purposes of the invention are adoxal (2,6,10-trimethyl-9-undecenal), anisaldehyde (4-methoxybenzaldehyde), cymal (3-(4-isopropylphenyl)-2-methylpropanal), ethylvanillin, florhydral (3-(3-isopropylphenyl)butanal)), helional (3-(3,4-methylenedioxyphenyl)-2-methylpropanal), heliotropin, hydroxycitronellal, lauraldehyde, lyral (3- and 4-(4-hydroxy-4-methylpentyl)-3-cyclohexene-1-carboxaldehyde), methylnonylacetaldehyde, lilial (3-(4-tert-butylphenyl)-2-methylpropanal), phenylacetaldehyde, undecylenaldehyde, vanillin, 2,6,10-trimethyl-9-undecenal, 3-dodecen-1-al, alpha-n-amylcinnamaldehyde, melonal (2,6-dimethyl-5-heptenal), 2,4-dimethyl-3-cyclohexene-1-carboxaldehyde (triplal), 4-methoxybenzaldehyde, benzaldehyde, 3-(4-tert-butylphenyl)propanal, 2-methyl-3-(para-methoxyphenyl)propanal, 2-methyl-4-(2,6,6-trimethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl)propanal, 1-decanal, 2,6-dimethyl-5-heptenal, 4-(tricyclo[5.2.1.0(2,6)]-decylidene-8)-butanal, octahydro-4,7-methane-1H-indenecarboxaldehyde, 3-ethoxy-4-hydroxybenzaldehyde, para-ethyl-alpha,alpha-dimethylhydrocinnamaldehyde, alpha-methyl-3,4-(methylenedioxy)hydrocinnamaldehyde, 3,4-methylenedioxybenzaldehyde, alpha-n-hexylcinnamaldehyde, m-cymene-7-carboxaldehyde, alpha-methylphenylacetaldehyde, 7-hydroxy-3,7-dimethyloctanal, undecenal, 2,4,6-trimethyl-3-cyclohexene-1-carboxaldehyde, 4-(3)(4-methyl-3-pentenyl)-3-cyclohexenecarboxaldehyde, 1-dodecanal, 2,4-dimethylcyclohexene-3-carboxaldehyde, 4-(4-hydroxy-4-methylpentyl)-3-cylohexene-1-carboxaldehyde, 7-methoxy-3,7-dimethyloctan-1-al, 2-methylundecanal, 2-methyldecanal, 1-nonanal, 1-octanal, 2,6,10-trimethyl-5,9-undecadienal, 2-methyl-3-(4-tert-butyl)propanal, dihydrocinnamaldehyde, 1-methyl-4-(4-methyl-3-pentenyl)-3-cyclohexene-1-carboxaldehyde, 5- or 6-methoxyhexahydro-4,7-methane indane-1- or -2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3,7-dimethyloctanal, trans-4-decenal, 2,6-nonadienal, para-tolylacetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexenecarboxaldehyde, 3,7-dimethyl-2-methylene-6-octenal, phenoxyacetaldehyde, 5,9-dimethyl-4,8-decadienal, peony aldehyde (6,10-dimethyl-3-oxa-5,9-undecadien-1-al), hexahydro-4,7-methane indane-1-carboxaldehyde, 2-methyloctanal, alpha-methyl-4-(1-methylethyl)benzylacetaldehyde, 6,6-dimethyl-2-norpinene-2-propionaldehyde, para-methylphenoxyacetaldehyde, 2-methyl-3-phenyl-2-propen-1-al, 3,5,5-trimethylhexanal, hexahydro-8,8-dimethyl-2-naphthaldehyde, 3-propylbicyclo[2.2.1]-hept-5-ene-2-carbaldehyde, 9-decenal, 3-methyl-5-phenyl-1-pentanal, methylnonylacetaldehyde, hexanal, and trans-2-hexenal. The fragrance aldehydes most preferred for purposes of the invention are lilial, helional, anisaldehyde, cyclamenaldehyde, triplal, melonal, methylundecanal, undecanal, nonanal, and octanal.

Particularly preferred fragrance ketones for purposes of the invention are methyl beta-naphthyl ketone, musk indanone (1,2,3,5,6,7-hexahydro-1,1,2,3,3-pentamethyl-4H-inden-4-one), tonalid (6-acetyl-1,1,2,4,4,7-hexamethyltetraline), alpha-damascone, beta-damascone, delta-damascone, isodamascone, damascenone, methyldihydrojasmonate, menthone, carvone, camphor, koavone (3,4,5,6,6-pentamethylhept-3-en-2-one), fenchone, alpha-ionone, beta-ionon, gamma-methyl-ionone, fleuramone (2-heptylcyclopentanone), dihydrojasmone, cis-jasmone, iso-E-Super (1-(1,2,3,4,5,6,7,8-octahydro-2,3,8,8-tetramethyl-2-naphthalenyl)ethan-1-one (and isomers)), methyl cedrenyl ketone, acetophenone, methylacetophenone, para-methoxyacetophenone, methyl beta-naphthyl ketone, benzylacetone, benzophenone, para-hydroxyphenylbutanone, celery ketone (3-methyl-5-propyl-2-cyclohexenone), 6-isopropyldecahydro-2-naphtone, dimethyloctenone, frescomenthe (2-butan-2-ylcyclohexan-1-one), 4-(1-ethoxyvinyl)-3,3,5,5-tetramethylcyclohexanone, methylheptenone, 2-(2-(4-methyl-3-cyclohexen-1-yl)propyl)cyclopentanone, 1-(p-menthen-6(2)yl)-1-propanone, 4-(4-hydroxy-3-methoxyphenyl)-2-butanone, 2-acetyl-3,3-dimethylnorbornane, 6,7-dihydro -1,1,2,3,3-pentamethyl-4(5H)indanone, 4-damascol, dulcinyl (4-(1,3-benzodioxol-5-yl)butan-2-one), hexalone (1-(2,6,6-trimethyl-2-cyclohexen-1-yl)-1,6-heptadien-3-one), isocyclemone E (2-acetonaphthone-1,2,3,4,5,6,7,8-octahydro-2,3,8,8-tetramethyl), methyl nonyl ketone, methylcyclocitrone, methyl lavender ketone, orivone (4-tert-amylcyclohexanone), 4-tert-butylcyclohexanone, delphone (2-pentylcyclopentanone), muscone (CAS 541-91-3), neobutenone (1-(5,5-dimethyl-1-cyclohexenyl)pent-4-en-1-one), plicatone (CAS 41724-19-0), veloutone (2,2,5-trimethyl-5-pentylcyclopentan-1-one), 2,4,4,7-tetramethyloct-6-en-3-one, and tetrameran (6,10-dimethylundecen-2-one).

Further fragrances selected from aldehydes and ketones are described in Steffen Arctander, Aroma Chemicals vol. 1 ISBN: 0-931710-37-5, Aroma Chemicals vol. 2: ISBN: 0-931710-38-3, published 1960 and 1969 respectively, reprinted 2000.

As is evident from the compounds recited above by way of examples, the fragrance aldehydes and ketones can have an aliphatic, cycloaliphatic, aromatic, ethylenically unsaturated structure, or a combination of said structures. Further heteroatoms or polycyclic structures can also be present. The structures can have suitable substituents, such as hydroxyl or amino groups.

For manufacture of the compounds of the general formula (I) to be used according to the present invention, a compound of the general formula (II) can be reacted with aldehydes, ketones, or mixtures of ketone and aldehydes, accompanied by ring closure. According to a preferred embodiment of the invention, the compounds of the general formula (I) are derived from a molecule of the general formula (II) and two aldehyde molecules that can be the same or different, or from one aldehyde molecule and one ketone molecule. Upon reaction of less-than-stoichiometric quantities of aldehydes and/or ketones, monocyclic compounds are also present in the product mixture. The proportion of bicyclic to monocyclic compounds can, however, easily be adjusted by selecting the molar ratio between aldehyde/ketone and the compound of the general formula (II).

The reaction is carried out by preference in a suitable solvent or in situ. Suitable solvents are, for example, aromatic hydrocarbons such as toluene. The reaction is carried out by preference at a temperature in the range from 80 to 150° C., particularly preferably 100 to 140° C. For example, the compound of the general formula (II) is made ready under a nitrogen atmosphere together with the desired ketone and/or aldehyde in the solvent. The reaction mixture is then heated. Heating is often then performed under reflux on a water separator. The reaction product obtained is isolated and optionally purified using usual methods. WO 2007/087977 A1, to which reference is hereby made, describes in detail the manufacture of compounds of the general formula (I), also referring to synthesis examples.

The compounds of the general formula (I) can release the bound fragrance aldehydes and fragrance ketones under ambient conditions. “Ambient conditions” in this context are the typical ambient conditions in the human living environment or on human skin. According to the present invention, the compounds of the general formula (I) are used in the perfume compositions as mixtures with the corresponding aldehydes or ketones.

According to a preferred embodiment of the invention, the perfume compositions according to the present invention are notable for the fact that the molar ratio of fragrance aldehyde and/or fragrance ketone to the corresponding oxazolidine fragrance precursor is 20:1 to 1:20, by preference 10:1 to 1:10, advantageously 5:1 to 1:5, more advantageously 3:1 to 1:3, even more advantageously 2:1 to 1:2, and in particular 1.2:1 to 1:1.2. It has been found that such mixtures of fragrance aldehyde and/or fragrance ketone and corresponding oxazolidine fragrance precursor produce particularly good results for purposes of this invention, in particular with regard to the stability and pleasant odor of the perfume composition and of the products containing it, and with regard to the scent of the items (such as, in particular, textiles) treated therewith.

Most preferred in this context are the corresponding mixtures of compounds of the general formula I in which the residues R², R⁴, R⁵, R⁷ signify hydrogen, the residues R¹ and R³ each signify a C₆₋₂₄ hydrocarbon residue (preferably a C₇₋₂₄ hydrocarbon residue), where the hydrocarbon residue can be acyclic or cyclic, substituted or unsubstituted, branched or unbranched, and saturated or unsaturated, and the residue R⁶ denotes hydrogen or a methyl, ethyl, or hydroxylmethyl residue, and where in both structural elements —CR¹R² or —CR³R⁴, the residues R¹ and R² or R³ and R⁴ each yield, in a compound of the general formula R¹—C(═O)—R² or R³—C(═O)R⁴, a fragrance aldehyde, by preference the same fragrance aldehyde, selected in particular from lilial, helional, anisaldehyde, cyclamenaldehyde, triplal, methylundecanal, nonanal, undecanal, and octanal.

For purposes of a preferred embodiment of the invention, the perfume composition according to the present invention can be made up substantially only of components (a) and (b), i.e. of fragrance aldehyde and/or fragrance ketone as well as an oxazolidine fragrance precursor, corresponding exactly to that fragrance aldehyde and/or fragrance ketone, that can release the same fragrance aldehyde or the same fragrance ketone and that corresponds to the general formula (I).

“Substantially” means here that this preferred perfume composition is made up, at a proportion of >90 weight prevent (wt %), by preference >95 wt %, and in particular >99 wt % or even 100 wt %, of components (a) and (b). The perfume composition can in principle encompass further constituents, in particular further fragrances and/or solvents. Adjuvants typical of perfume compositions can likewise be contained, for example antioxidants (general term for compounds of various chemical structures that inhibit or prevent undesired changes, caused by the action of oxygen and by other oxidative processes, in the compositions to be protected), preservatives (general term for compounds of various chemical structures that inhibit or prevent undesired changes, caused by the action of microorganisms or microbes, in the compositions to be protected), or e.g., fixatives.

For purposes of a further preferred embodiment of the invention, however, the perfume composition according to the present invention can also contain larger quantities of further constituents, in particular further fragrances and/or solvents.

Fixatives, which are optionally usable as adjuvants, are substances that can impart elevated stability to fragrances. Particularly suitable as fixatives are the so-called inherent fixatives, which because of their low volatility retain their inherent odor over a long period without preventing other, more-volatile components from expressing their odor, such as in particular the synthetic musks, also the so-called pseudofixatives constituting low-fragrance substances, for example diethylene glycol methyl ether, as well as furthermore the fixatives that fix by way of adsorptive forces, such as in particular extracts of labdanum, styrax, tolu balsam, benzoin, iris, oakmoss or opoponax, etc.

Suitable optional solvents are in particular those usual in perfumery, such as by preference dipropylene glycol, diethylene glycol, isopropyl myristate, ethanol, propylene glycol, and/or castor oil. Other suitable optional adjuvants are, for example, complexing agents.

According to a particularly preferred embodiment of the invention, the perfume composition according to the present invention contains further fragrances.

Components (a) and (b) can together account for 100 wt % of the perfume composition according to the present invention, which corresponds to a preferred embodiment. If components (a) and (b) are contained in the perfume composition according to the present invention, in total, in quantities from 0.01 to 99 wt %, by preference 0.1 to 50 wt %, in particular 1 to 30 wt %, based on the total perfume composition, a further preferred embodiment of the invention then exists. Suitable lower limits in this context can also, for example, be 2, 3, 4, 5, 10, 15, 20, 25, or 30 wt %.

According to a preferred embodiment of the invention, the perfume composition according to the present invention contains in total >20 wt %, by preference >30 wt %, advantageously >40 wt %, in particular >50 wt % fragrances, for example >60 wt % or >70 wt % fragrances, based on the total composition.

The perfume compositions according to the present invention can also, in principle, contain surfactants as optional adjuvants. It is particularly preferred, however, that if surfactants are contained at all, the perfume composition encompass <15 wt %, by preference <5 wt %, in particular <1 wt % surfactants. The surfactant content can also be below 10 wt % or below 3 wt % or below 0.5 wt %, below 0.1 wt %, or below 0.01 wt %. If surfactants are contained, which is optional, a suitable minimum quantity can then be, for example, 0.0001 wt % or 0.001 wt %, “wt %” being based in each case on the total composition. The term “surfactants” for purposes of the invention also includes the emulsifiers as surface-active substances. Emulsifiers preferred for use are ethoxylated fatty alcohols, ethoxylated triglycerides, sorbitan fatty acid esters, and hydrogenated ethoxylated castor oil.

According to a further preferred embodiment of the invention, the perfume composition according to the present invention is liquid or gel-like. It can in principle also be solid.

The further fragrances that can optionally be contained in the perfume composition according to the present invention are not subject to any particular limitations. Individual fragrance compounds of natural or synthetic origin, e.g., of the ester, ether, aldehyde, ketone, alcohol, and hydrocarbon types, can therefore be used. Fragrance compounds of the ester type are, for example, benzyl acetate, phenoxyethyl isobutyrate, p-tert-butylcyclohexyl acetate, linalyl acetate, dimethylbenzylcarbinyl acetate (DMBCA), phenylethyl acetate, benzyl acetate, ethylmethylphenyl glycinate, allylcyclohexyl propionate, styrallyl propionate, benzyl salicylate, cyclohexyl salicylate, floramate, melusate, and jasmecyclate. The ethers include, for example, benzyl ethyl ether and ambroxan; the aldehydes, for example, the linear alkanals having 8 to 18 carbon atoms, citral, citronellal, citronellyloxyacetaldehyde, cyclamenaldehyde (3-(4-propan-2-ylphenyl)butanal, lilial, and bourgeonal; the ketones, for example, the ionones, α-isomethylionone and methyl cedryl ketone; the alcohols, anethol, citronellol, eugenol, geraniol, linalool, phenylethyl alcohol and terpineol; and the hydrocarbons include principally the terpenes such as limonene and pinene. Preferably, however, mixtures of different fragrances that together produce an attractive fragrance note are used.

The perfume compositions according to the present invention can also contain natural fragrance mixtures such as those accessible from plant sources, for example pine, citrus, jasmine, patchouli, rose, or ylang-ylang oil. Also suitable are muscatel sage oil, chamomile oil, clove oil, lemon balm oil, mint oil, cinnamon leaf oil, linden blossom oil, juniper berry oil, vetiver oil, olibanum oil, galbanum oil, and labdanum oil, as well as orange blossom oil, neroli oil, orange peel oil, and sandalwood oil.

Further conventional fragrances that can be contained, in the context of the present invention, in the perfume composition according to the present invention are, for example, the essential oils such as angelica oil, anise oil, arnica flower oil, basil oil, bay oil, champaca flower oil, silver fir oil, silver fir cone oil, elemi oil, eucalyptus oil, fennel oil, fir needle oil, galbanum oil, geranium oil, gingergrass oil, guaiac wood oil, balsam gurjun oil, helichrysum oil, ho oil, ginger oil, iris oil, cajeput oil, calamus oil, chamomile oil, camphor oil, kanaga oil, cardamom oil, cassia oil, pine needle oil, balsam copaiva oil, coriander oil, curled peppermint oil, caraway oil, cumin oil, lavender oil, lemon grass oil, lime oil, tangerine oil, lemon balm oil, ambrette seed oil, myrrh oil, clove oil, neroli oil, niaouli oil, olibanum oil, oregano oil, palmarosa oil, patchouli oil, balsam peru oil, petitgrain oil, pepper oil, peppermint oil, pimento oil, pine oil, rose oil, rosemary oil, sandalwood oil, celery oil, spike lavender oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil, and cypress oil, as well as ambrettolide, ambroxan, α-amylcinnamaldehyde, anethole, anisealdehyde, anise alcohol, anisole, anthranilic acid methyl ester, acetophenone, benzyl acetone, benzaldehyde, benzoic acid ethyl ester, benzophenone, benzyl alcohol, benzyl acetate, benzyl benzoate, benzyl formate, benzyl valerate, borneol, bornyl acetate, boisambrene forte, α-bromostyrene, n-decylaldehyde, n-dodecylaldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaldehyde, hydroxycinnamyl alcohol, indole, irone, isoeugenol, isoeugenol methyl ether, isosafrol, jasmone, camphor, carvacrol, carvone, p-cresol methyl ether, coumarin, p-methoxyacetophenone, methyl n-amyl ketone, methylanthranilic acid methyl ester, p-methylacetophenone, methylchavicol, p-methylquinoline, methyl β-naphthyl ketone, methyl-n-nonylacetaldehyde, methyl n-nonyl ketone, muscone, β-naphthol ethyl ether, β-naphthol methyl ether, nerol, n-nonylaldehyde, nonyl alcohol, n-octylaldehyde, p-oxyacetophenone, pentadecanolide, β-phenylethyl alcohol, phenylacetic acid, pulegone, safrole, salicylic acid isoamyl ester, salicylic acid methyl ester, salicylic acid hexyl ester, salicylic acid cyclohexyl ester, santalol, skatole, terpineol, thymene, thymol, troenan, γ-undelactone, vanillin, veratrumaldehyde, cinnamaldehyde, cinnamyl alcohol, cinnamic acid, cinnamic acid ethyl ester, cinnamic acid benzyl ester, diphenyl oxide, limonene, linalool, linalyl acetate and linalyl propionate, melusate, menthol, menthone, methyl-n-heptenone, pinene, phenylacetaldehyde, terpinyl acetate, citral, citronellal, and mixtures thereof.

As already indicated, the perfume compositions according to the present invention make possible advantages in the scenting of consumer products such as, in particular, washing or cleaning agents, since they can improve the intensity of the product odor per se, and also offer scenting advantages in the context of use of the consumer products, in particular with regard to a long-lasting scent of the treated item. The perfume compositions according to the present invention can be incorporated without difficulty, and in stable fashion, into a variety of consumer products such as, in particular, washing or cleaning agents, cosmetics, air fresheners, adhesives. Particularly preferred consumer products according to the present invention are washing or cleaning agents, under which, for purposes of the invention, are also to be subsumed the textile post-treatment agents such as, in particular, fabric softeners or hygiene rinses. These are known per se to one skilled in the art. Particularly preferred washing or cleaning agents are solid, in particular powdered washing agents, liquid, in particular gelled washing agents, and liquid fabric softeners. The washing or cleaning agents can also be present in the form of small pouches, in the form of sheets, or in tablet form. The perfume compositions according to the present invention can also be encapsulated prior to incorporation into the washing or cleaning agent.

A further subject of the invention is thus a perfumed consumer product (in particular a washing or cleaning agent, cosmetic agent, room scenting agent, and/or adhesives) that contains a perfumed composition according to the present invention as described above. The respective consumer product furthermore advantageously contains the constituents usual for the particular product. Use of the perfume composition according to the present invention in washing or cleaning agents is particularly advantageous.

A further subject of the invention is a washing or cleaning agent containing a perfume composition according to the present invention in quantities from 0.0001 to 15 wt %, “wt %” being based on the total agent. Preferred lower limits for the perfume composition according to the present invention in the washing or cleaning agent can also be 0.001 wt %, 0.01 wt %, or 0.1 wt %. Preferred upper limits for the perfume composition according to the present invention in the washing or cleaning agent can also be 10 wt %, 5 wt %, or 3 wt %.

The perfume compositions according to the present invention and washing or cleaning agents according to the present invention have proven to be particularly advantageous in the context of the scenting of textiles.

A further subject of the invention is accordingly a method for scenting textiles, where the textiles are subjected to a textile treatment process utilizing a perfume composition according to the present invention or a washing or cleaning agent according to the present invention.

Preferred textile treatment processes are washing processes, which can be carried out manually or in particular automatically, by preference in an automatic washing machine.

A further advantage that has become evident is that even after automatic laundry drying, a good and also long-lasting textile scent can be obtained.

It is moreover advantageous that the total concentration of perfume in the product (e.g., in the washing agent) can be reduced as a result of the invention with no loss of pleasant odor. Efficient perfuming is thus enabled.

All in all, a prolongation of the scent effect of the washing or cleaning agent is made possible. It also becomes possible to achieve a long-lasting fresh odor upon use of the washing or cleaning agent.

A further subject of the present invention is thus the use of a perfume composition according to the present invention in a washing or cleaning agent in order to prolong the scent effect of the washing or cleaning agent and/or to achieve a long-lasting fresh odor upon use of the washing or cleaning agent.

Washing or cleaning agents according to the present invention preferably contain, besides the perfume compositions according to the present invention, at least one, by preference multiple active components, in particular components having washing, care-providing, and/or cleaning activity, advantageously selected from the group encompassing anionic surfactants, cationic surfactants, amphoteric surfactants, nonionic surfactants, acidifying agents, alkalizing agents, anti-creasing compounds, antibacterial substances, antioxidants, antiredeposition agents, antistatic agents, builder substances, bleaching agents, bleach activators, bleach stabilizers, bleach catalysts, ironing adjuvants, fragrances, shrinkage preventers, electrolytes, enzymes, color protectants, coloring agents, dyes, color transfer inhibitors, fluorescent agents, fungicides, germicides, odor-complexing substances, hydrotropes, rinse aids, complexing agents, preservatives, corrosion inhibitors, optical brighteners, luster agents, pH adjusting agents, proofing and impregnation agents, polymers, swelling and anti-slip agents, foam inhibitors, sheet silicates, dirt-repelling substances, silver protectants, silicone oils, UV protection substances, viscosity regulators, thickening agents, discoloration inhibitors, anti-gray agents, vitamins, and/or avivage active substances.

The quantities of the further possible ingredients in the washing or cleaning agents according to the present invention are aimed in each case toward the intended use of the relevant agents, and one skilled in the art is familiar in principle with the orders of magnitude of the quantities of optional ingredients to be used, or can gather them from the relevant technical literature.

The surfactant content, for example, will be selected to be higher or lower depending on the intended use of the washing or cleaning agents according to the present invention. For example, the surfactant content of, for example, washing agents is usually between e.g., 5 and 50 wt %, by preference between 10 and 30 wt %, and in particular between 15 and 25 wt %, while, for example, cleaning agents for automatic dishwashing usually contain, for example, between 0.1 and 10 wt %, by preference between 0.5 and 7.5 wt %, and in particular between 1 and 5 wt % surfactants.

The washing or cleaning agents according to the present invention can by preference contain surfactants; anionic surfactants, nonionic surfactants, and mixtures thereof, but also cationic surfactants, are appropriate in particular.

Among the optionally usable nonionic surfactants are the alkoxylates, in particular ethoxylates and/or propoxylates, of saturated or mono- to polyunsaturated linear or branched-chain alcohols having 10 to 22 carbon atoms, by preference 12 to 18 carbon atoms. The degree of alkoxylation of the alcohols is as a rule between 1 and 20, by preference between 3 and 10. They can be manufactured, in known fashion, by reacting the corresponding alcohols with the corresponding alkylene oxides. The derivatives of the fatty alcohols are particularly suitable, although their branched-chain isomers, in particular so-called oxo alcohols, can also be used to manufacture usable alkoxylates. The alkoxylates, in particular the ethoxylates, of primary alcohols having linear, in particular dodecyl, tetradecyl, hexadecyl, or octadecyl residues, and mixtures thereof, are accordingly usable. Also usable are corresponding alkoxylation products of alkylamines, of vicinal diols, and of carboxylic acid amides that correspond to the aforesaid alcohols in terms of the alkyl portion. Additionally suitable are the ethylene-oxide and/or propylene-oxide insertion products of fatty acid alkyl esters (so-called fatty acid polyhydroxyamides).

So-called alkylpolyglycosides suitable for incorporation into the agents according to the present invention are compounds of the general formula (G)ₙ-OR⁸, in which R⁸ signifies an alkyl or alkenyl residue having 8 to 22 carbon atoms, G a glycose unit, and n a number between 1 and 10. The glycoside component (G)ₙ refers to oligomers or polymers from naturally occurring aldose or ketose monomers, among which are included, in particular, glucose, mannose, fructose, galactose, talose, gulose, altrose, allose, idose, ribose, arabinose, xylose, and lyxose. The oligomers made up of glycosidically linked monomers of this kind are characterized not only by the nature of the sugars contained in them but also by their number (the so-called degree of oligomerization). The degree of oligomerization n, constituting a magnitude to be ascertained analytically, generally assumes fractional numerical values; its value is between 1 and 10, below 1.5 for the glycosides used by preference, in particular between 1.2 and 1.4. Because of its good availability, glucose is a preferred monomer module. The alkyl or alkenyl portion R⁸ of the glycosides preferably likewise derives from easily accessible derivatives of renewable raw materials, in particular from fatty alcohols, although their branched-chain isomers, in particular so-called oxo alcohols, can also be used for the manufacture of usable glycosides. The primary alcohols having linear octyl, decyl, dodecyl, tetradecyl, hexadecyl, or octadecyl residues, and mixtures thereof, are accordingly usable. Particularly preferred alkylglycosides contain a coconut oil alkyl residue, i.e. mixtures where substantially R⁸=dodecyl and R⁸=tetradecyl.

Nonionic surfactant is optionally contained in washing or cleaning agents according to the present invention by preference in quantities from 0.1 wt % to 30 wt %, in particular from 1 wt % to 25 wt %, “wt %” being based on the total washing or cleaning agent.

The washing or cleaning agents can instead or additionally contain further optional surfactants, by preference anionic surfactants.

Anionic surfactants of the sulfate or sulfonate type are by preference optionally contained, in quantities by preference not above 30 wt %, in particular from 0.1 wt % to 18 wt %, based in each case on the total washing or cleaning agent. Anionic surfactants particularly suitable for use in the washing or cleaning agents according to the present invention are the alkyl and/or alkenyl sulfates, having 8 to 22 carbon atoms, which carry an alkali-, ammonium-, or alkyl- or hydroxyalkyl-substituted ammonium ion as counter-cation. The derivatives of fatty alcohols having, in particular, 12 to 18 carbon atoms, and their branched-chain analogs (the so-called oxo alcohols), are preferred. The alkyl and alkenyl sulfates can be manufactured in known fashion by reacting the corresponding alcohol component with a usual sulfating reagent, in particular sulfur trioxide or chlorosulfonic acid, followed by neutralization with alkali-, ammonium-, or alkyl- or hydroxyalkyl-substituted ammonium bases. Such alkyl and/or alkenyl sulfates are optionally contained in the washing or cleaning agents by preference in quantities from 0.1 wt % to 20 wt %, in particular from 0.5 wt % to 18 wt %.

Also included among the usable surfactants of the sulfate type are sulfated alkoxylation products of the aforesaid alcohols (so-called ether sulfates). Such ether sulfates contain by preference 2 to 30, in particular 4 to 10 ethylene glycol groups per molecule. Included among the usable anionic surfactants of the sulfonate type are the α-sulfo esters obtainable by reacting fatty acid esters with sulfur trioxide and subsequent neutralization, in particular the sulfonation products deriving from fatty acids having 8 to 22 carbon atoms, by preference 12 to 18 carbon atoms, and linear alcohols having 1 to 6 carbon atoms, by preference 1 to 4 carbon atoms, and the sulfofatty acids proceeding therefrom by formal saponification.

Anionic surfactants optionally usable with particular preference are alkylbenzenesulfonates, such as e.g., sodium dodecylbenzenesulfonate.

Anionic surfactant is optionally contained in washing or cleaning agents according to the present invention by preference in quantities from 0.1 wt % to 30 wt %, in particular from 1 wt % to 25 wt %, “wt %” being based on the total washing or cleaning agent.

Further appropriate optional surfactant ingredients of the washing or cleaning agents are soaps; saturated fatty acid soaps such as the salts of lauric acid, myristic acid, palmitic acid, or stearic acid, as well as soaps derived from natural fatty acid mixtures, for example coconut, palm-kernel, or tallow fatty acids, are suitable. Those soap mixtures that are made up of 50 wt % to 100 wt % saturated C₁₂ to C₁₈ fatty acid soaps and up to 50 wt % oleic acid soap are particularly preferred. Soap is optionally contained in the washing or cleaning agents according to the present invention by preference in quantities from 0.1 wt % to 5 wt %. Larger quantities of soap (up to 20 wt %) can, however, also be contained in particular in liquid washing or cleaning agents.

Cationic surfactants can also be optionally contained in the washing or cleaning agents according to the present invention. Examples of cationic surfactants are quaternary ammonium compounds having by preference one or, in particular, two hydrophobic alkyl residues. Esterquats are particularly preferred, i.e. quaternary ammonium compounds having two hydrophobic residues that each contain an ester group as a “defined break point” for easier biodegradability. Esterquats preferred for use are methyl-N-(2-hydroxyethyl)-N,N-di(tallowacyloxyethyl)ammonium methosulfate, bis-(palmitoylo xyethyl) hydro xyethylmethylammonium methosulfate, 1,2-bis-[tallowacyloxy]-3-trimethylammonium propane chloride, N,N-dimethyl-N,N-di(tallowacyloxyethyl)ammonium methosulfate, or methyl-N,N-bis(stearoyloxyethyl)-N-(2-hydroxyethyl)ammonium methosulfate.

The cationic surfactants are optionally contained in the washing or cleaning agents according to the present invention in quantities of, by preference, 0.05 to 20 wt % based on the entire washing or cleaning agent. Quantities from 0.1 to 5 wt % are particularly preferred.

According to a preferred embodiment of the invention, surfactants are contained in washing or cleaning agents according to the present invention in a total quantity by preference from 5 wt % to 50 wt %, in particular from 8 wt % to 30 wt %. In laundry post-treatment agents in particular, by preference up to 30 wt %, in particular 5 wt % to 15 wt % surfactants are used, among them preferably cationic surfactants at least in part.

A washing or cleaning agent according to the present invention can by preference contain at least one builder, by preference a water-soluble and/or water-insoluble, organic and/or inorganic builder. The use of water-soluble builders is preferred.

Included among the water-soluble organic builder substances are polycarboxylic acids, in particular citric acid and sugar acids, monomeric and polymeric aminopolycarboxylic acids, in particular methylglycinediacetic acid, nitrilotriacetic acid, and ethylenediaminetetraacetic acid, as well as polyaspartic acid, polyphosphonic acids, in particular aminotris(methylenephosphonic acid), ethylenediaminetetrakis(methylenephosphonic acid), and 1-hydro xyethane-1,1-diphosphonic acid, polymeric hydroxy compounds such as dextrin, as well as polymeric (poly)carboxylic acids, polymeric acrylic acids, methacrylic acids, maleic acids, and mixed polymers thereof, which can also contain, polymerized into them, small proportions of polymerizable substances having no carboxylic-acid functionality. Compounds of this class that are suitable although less preferred are copolymers of acrylic acid or methacrylic acid with vinyl ethers, such as vinyl methyl ethers, vinyl esters, ethylene, propylene, and styrene, in which the proportion of acid is at least 50 wt %.

Organic builder substances can be contained in the washing or cleaning agents according to the present invention, if desired, in quantities of up to 40 wt %, in particular up to 25 wt %, and by preference from 1 wt % to 8 wt %. Quantities close to the aforesaid upper limit are used by preference in pasty or liquid, in particular water-containing, washing or cleaning agents according to the present invention. Washing or cleaning agents such as laundry post-treatment agents, for example fabric softeners, according to the present invention can also, if applicable, be free of organic builder.

Possibilities as water-soluble inorganic builder materials are, in particular, alkali silicates and polyphosphates, by preference sodium triphosphate. Crystalline or amorphous alkali aluminosilicates are optionally used in particular as water-insoluble, water-dispersible inorganic builder materials, in quantities of e.g., up to 50 wt %, by preference not above 40 wt %, and in liquid agents in particular from 1 wt % to 5 wt %, in the washing or cleaning agents according to the present invention. Among these, the crystalline sodium aluminosilicates of washing-agent quality, in particular zeolite A, P, and if applicable X, are preferred. Quantities close to the aforesaid upper limit are optionally used by preference in solid, particulate agents.

Suitable substitutes respectively partial substitutes for the aforesaid aluminosilicate are crystalline alkali silicates, which can be present alone or mixed with amorphous silicates. The alkali silicates usable in the washing or cleaning agents according to the present invention as builders have by preference a molar ratio of alkali oxide to SiO₂ below 0.95, in particular from 1:1.1 to 1:12, and can be present in amorphous or crystalline fashion. Amorphous alkali silicates are preferred.

It is also preferred for purposes of a further embodiment to use at most a small quantity of water-insoluble builder materials (such as e.g., zeolite), for example in quantities from 0 to 5 wt %, e.g., 0.1 to 2 wt %, based on the entire washing or cleaning agent.

Builder substances are optionally contained in the washing or cleaning agents according to the present invention by preference in quantities of up to 60 wt %, in particular from 5 wt % to 40 wt %. Laundry post-treatment agents, for example fabric softeners, according to the present invention are by preference free of inorganic builders.

Optionally usable peroxygen compounds that are suitable are, in particular, organic peracids respectively peracid salts of organic acids such as phthalimidopercapronic acid, perbenzoic acid, or salts of diperdodecanedioic acid, hydrogen peroxide, and inorganic salts that release hydrogen peroxide under utilization conditions, such as perborate, percarbonate, and/or persilicate. If solid peroxygen compounds are to be used, they can be utilized in the form of powders or granulates, which in principle can also be encased in known fashion. Alkali percarbonate, alkali perborate monohydrate, or (in particular in liquid agents) hydrogen peroxide in the form of aqueous solutions that contain 3 wt % to 10 wt % hydrogen peroxide, can be used with particular preference. If a washing or cleaning agent according to the present invention contains bleaching agents, such as preferably peroxygen compounds, the latter are present in quantities of preferably up to 50 wt %, in particular from 5 wt % to 30 wt %. The optional addition of small quantities of known bleaching-agent stabilizers, for example phosphonates, borates or metaborates, and metasilicates, as well as magnesium salts such as magnesium sulfate, may be useful.

Compounds that, under perhydrolysis conditions, yield aliphatic peroxocarboxylic acids having by preference 1 to 10 carbon atoms, in particular 2 to 4 carbon atoms, and/or (optionally substituted) perbenzoic acid, can optionally be used as bleach activators. Substances that carry the O- and/or N-acyl groups having the aforesaid number of carbon atoms, and/or optionally substituted benzoyl groups, are suitable. Multiply acylated alkylenediamines, in particular tetraacetylethylendiamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenolsulfonates, in particular n-nonanoyl or isononanoyl oxybenzenesulfonate (n- or iso-NOBS), carboxylic acid anhydrides, in particular phthalic acid anhydride, acylated polyvalent alcohols, in particular triacetin, ethylene glycol diacetate, 2,5-diacetoxy-2,5-dihydrofuran, and enol esters, as well as acetylated sorbitol and mannitol respectively mixtures thereof, acylated sugar derivatives, in particular pentaacetylglucose (PAG), pentaacetylfructose, tetraacetylxylose and octaacetyllactose, as well as acetylated, optionally N-alkylated glucamine and gluconolactone, and/or N-acylated lactams, for example N-benzoylcaprolactam, are preferred. Hydrophilically substituted acyl acetates and acyl lactams are likewise used in preferred fashion. Combinations of conventional bleach activators can also be used. Such bleach activators can be contained in the usual quantity range, by preference in quantities from 1 wt % to 10 wt %, in particular 2 wt % to 8 wt %, based on the total agent.

Suitable enzymes optionally usable in the washing or cleaning agents are those from the class of the proteases, cutinases, amylases, pullulanases, hemicellulases, cellulases, lipases, oxidases, and peroxidases, as well as mixtures thereof. Enzymatic active substances recovered from fungi or bacteria, such as Bacillus subtilis, Bacillus licheniformis, Streptomyces griseus, Humicola lanuginosa, Humicola insolens, Pseudomonas pseudoalcaligenes, or Pseudomonas cepacia, are particularly suitable. The enzymes that are optionally used can be adsorbed onto carrier substances and/or embedded into encasing substances in order to protect them from premature inactivation. They are contained in the washing or cleaning agents according to the present invention by preference in quantities not above 5 wt %, in particular from 0.2 wt % to 2 wt %.

The washing or cleaning agents can optionally contain as optical brighteners, for example, derivatives of diaminostilbenedisulfonic acid or alkali metal salts thereof. Suitable, for example, are salts of 4,4′-bis(2-anilino-4-morpholino-1,3,5-triazinyl-6-amino)stilbene-2,2′-disulfonic acid, or compounds of similar structure that carry, instead of the morpholino group, a diethanolamino group, a methylamino group, an anilino group, or a 2-methoxyethylamino group. Brighteners of the substituted diphenylstyryl type can also be present, for example the alkali salts of 4,4′-bis(2-sulfostyryl)diphenyl, of 4,4′-bis(4-chloro-3-sulfostyryl)diphenyl, or of 4-(4-chlorostyryl)-4′-(2-sulfostyryl)diphenyl. Mixtures of the aforesaid brighteners can also be used.

Included among the optionally usable foam inhibitors are, for example, organopolysiloxanes and mixtures thereof with microfine, optionally silanated silicic acid, as well as paraffin waxes and mixtures thereof with silanated silicic acid or bis-fatty acid alkylenediamides. Mixtures of different foam inhibitors, for example those made of silicones, paraffins, or waxes, can also be used with advantage. The optional foam inhibitors, in particular silicone- and/or paraffin-containing foam inhibitors, are by preference bound to a granular carrier substance that is soluble respectively dispersible in water. Mixtures of paraffins and bistearylethylenediamides are particularly preferred in this context.

In addition, the washing or cleaning agents can optionally also contain components that positively influence the ability of oils and fats to be washed out of textiles (so-called “soil release active substances”). This effect becomes particularly apparent when the soiled textile is one that has already been previously washed several times with a washing agent that contains this oil- and fat-releasing component. The preferred oil- and fat-releasing components include, for example, nonionic cellulose ethers such as methyl cellulose and methylhydroxypropyl cellulose having a 15 to 30 wt % proportion of methoxyl groups and a 1 to 15 wt % proportion of hydroxypropoxyl groups, based in each case on the nonionic cellulose ethers, as well as polymers, known from the existing art, of phthalic acid and/or terephthalic acid or of their derivatives with monomeric and/or polymeric diols, in particular polymers of ethylene terephthalates and/or polyethylene glycol terephthalates or anionically and/or nonionically modified derivatives thereof.

The washing or cleaning agents can optionally also contain color transfer inhibitors, by preference in quantities from 0.1 wt % to 2 wt %, in particular 0.1 wt % to 1 wt %, which in a preferred embodiment of the invention are polymers of vinylpyrrolidone, vinylimidazole, vinylpyridine-N-oxide, or copolymers thereof. Also usable are both polyvinylpyrro lidones, N-vinylimidazo le/N-vinylpyrro lidone copo lymers, polyvinyloxazolidones, copolymers based on vinyl monomers and carboxylic acid amides, pyrrolidone-group-containing polyesters and polyamides, grafted polyamidoamines and polyethylenimines, polymers having amide groups made up of secondary amines, polyamine-N-oxide polymers, polyvinyl alcohols, and copolymers based on acrylamidoalkenylsulfonic acids.

The optionally usable anti-gray agents have the ability to keep dirt that has been detached from the textile fibers suspended in the bath. Water-soluble colloids, usually organic in nature, are suitable for this, for example starch, size, gelatin, salts of ethercarboxylic or ethersulfonic acids of starch or of cellulose, or salts of acid sulfuric-acid esters of cellulose or of starch. Water-soluble polyamides containing acid groups are also suitable for this purpose. Starch derivatives other than those recited above can also be used, for example aldehyde starches. Cellulose ethers such as carboxymethyl cellulose (sodium salt), methyl cellulose, hydroxyalkyl cellulose, and mixed ethers such as methylhydroxyethyl cellulose, methylhydroxypropyl cellulose, methylcarboxymethyl cellulose, and mixtures thereof can preferably be used, for example in quantities from 0.1 to 5 wt % based on the washing or cleaning agent, as optional anti-gray agents.

Included among the organic solvents optionally usable in the washing or cleaning agents according to the present invention, especially when the latter are present in liquid or pasty form, are alcohols having 1 to 4 carbon atoms, in particular methanol, ethanol, isopropanol, and tert-butanol, diols having 2 to 4 carbon atoms, in particular ethylene glycol and propylene glycol, as well as mixtures thereof, and the ethers derivable from the aforesaid compound classes. Water-miscible solvents of this kind can optionally be present in the washing or cleaning agents according to the present invention by preference in quantities not above 30 wt %, in particular from 6 wt % to 20 wt %.

In order to establish a desired pH that does not result of itself from mixture of the other components, the washing or cleaning agents according to the present invention can optionally contain acids, in particular citric acid, acetic acid, tartaric acid, malic acid, lactic acid, glycolic acid, succinic acid, glutaric acid, and/or adipic acid, but also mineral acids, in particular sulfuric acid, or bases, in particular ammonium hydroxides or alkali hydroxides. pH regulators of this kind can optionally be contained in the washing or cleaning agents according to the present invention in quantities by preference not above 20 wt %, in particular from 1.2 wt % to 17 wt %.

The manufacture of solid washing or cleaning agents according to the present invention can in principle occur in known fashion, for example by spray-drying or granulation; an optional peroxygen compound and optional bleach catalyst are, if applicable, added later. The perfume composition according to the present invention is by preference applied onto the washing or cleaning agent at the end of the manufacturing process, preferably by being sprayed on. A method comprising an extrusion step is preferred for the manufacture of washing or cleaning agents according to the present invention having an elevated bulk weight, in particular in the range from 650 g/l to 950 g/l. The manufacture of liquid washing or cleaning agents according to the present invention can likewise occur in known fashion, the perfume composition according to the present invention being by preference introduced into the washing or cleaning agent at the end of the manufacturing process.

According to a preferred embodiment, the teaching according to the present invention can be used to reduce the perfume proportion in consumer products such as washing, cleaning, and toiletry agents, since incorporation of the perfume composition according to the present invention allows not only particularly long-lasting but also particularly efficient perfuming to be ensured.

A preferred washing or cleaning agent according to the present invention is a solid, in particular powdered, washing agent that by preference can contain, alongside the perfume composition according to the present invention, components that are selected by preference from the following:
(a) anionic surfactants such as, by preference, alkylbenzenesulfonate, alkyl sulfate, e.g., in quantities by preference from 5 to 30 wt %,
(b) nonionic surfactants such as, by preference, fatty alcohol polyglycol ethers, alkylpolyglucoside, fatty acid glucamide, e.g., in quantities by preference from 0.5 to 15 wt %,
(c) builders such as, for example, polycarboxylate, sodium citrate, in quantities from, for example, 0 to 70 wt %, advantageously 5 to 60 wt %, by preference 10 to 55 wt %, in particular 15 to 40 wt %,
(d) alkalis such as, for example, sodium carbonate, in quantities e.g., from 0 to 35 wt %, advantageously 1 to 30 wt %, by preference 2 to 25 wt %, in particular 5 to 20 wt %,
(e) bleaching agents such as, for example, sodium perborate or sodium percarbonate, in quantities e.g., from 0 to 30 wt %, advantageously 5 to 25 wt %, by preference 10 to 20 wt %,
(f) corrosion inhibitors, e.g., sodium silicate, in quantities e.g.,, from 0 to 10 wt %, advantageously 1 to 6 wt %, by preference 2 to 5 wt %, in particular 3 to 4 wt %,
(g) stabilizers, e.g., phosphonates, advantageously 0 to 1 wt %,
(h) foam inhibitor, e.g., soap, silicone oils, paraffins, advantageously 0 to 4 wt %, by preference 0.1 to 3 wt %, in particular 0.2 to 1 wt %,
(i) enzymes, e.g., proteases, amylases, cellulases, lipases, advantageously 0 to 2 wt %, by preference 0.2 to 1 wt %, in particular 0.3 to 0.8 wt %,
(j) anti-gray agent, e.g., carboxymethyl cellulose, advantageously 0 to 1 wt %,
(k) discoloration inhibitor, e.g., polyvinylpyrrolidone derivatives, e.g., 0 to 2 wt %,
(l) adjusting agent, e.g., sodium sulfate, advantageously 0 to 20 wt %,
(m) optical brightener, e.g., stilbene derivative, biphenyl derivative, advantageously 0 to 0.4 wt %, in particular 0.1 to 0.3 wt %,
(n) optionally further fragrances,
(o) optionally water,
(p) optionally soap,
(q) optionally bleach activators,
(r) optionally cellulose derivatives,
(s) optionally dirt repellents,
“wt %” being based in each case on the total agent.

In a further preferred embodiment, the washing or cleaning agent according to the present invention is in solid form, in particular particulate form, and besides the perfume composition according to the present invention also contains 5 wt % to 55 wt % builders, 2.5 wt % to 20 wt % anionic surfactant, 1 wt % to 20 wt % nonionic surfactant, 1 wt % to 25 wt % bleaching agent, 0.5 wt % to 8 wt % bleach activator, and 0.1 wt % to 40 wt % adjusting agent, in particular alkali sulfate, as well as up to 2 wt %, in particular 0.4 wt % to 1.2 wt % enzyme, by preference enzyme prepared in particulate form, in particular protease, lipase, amylase, cellulase, and/or oxidoreductase. This embodiment can optionally also be free of bleaching agent and bleach activator.

In another preferred embodiment of the invention, the washing or cleaning agent according to the present invention is present in liquid form, by preference in gel form. Preferred liquid washing or cleaning agents have water contents of, for example, 10 to 95 wt %, by preference 20 to 80 wt %, and in particular 30 to 70 wt %, based on the total agent. In the case of liquid concentrates the water content can also be particularly low, e.g., ≦30 wt %, by preference ≦20 wt %, in particular ≦15 wt %, such as e.g., 0.1 to 10 wt %, “wt %” being based in each case on the total agent. The liquid consumer products can also contain non-aqueous solvents.

A preferred washing or cleaning according to the present invention is a liquid, in particular gel-type, washing agent that by preference can contain, alongside the perfume composition according to the present invention, components that are selected by preference from the following:
anionic surfactants such as, by preference, alkylbenzenesulfonate, alkyl sulfate, e.g., in quantities by preference from 5 to 40 wt %,
nonionic surfactants such as, by preference, fatty alcohol polyglycol ethers, alkylpolyglucoside, fatty acid glucamide, for example in quantities by preference from 0.5 to 25 wt %,
builders such as, for example, polycarboxylate, sodium citrate, advantageously 0 to 25 wt %, by preference 0.01 to 10 wt %, in particular 0.1 to 5 wt %,
foam inhibitor, e.g., silicone oils, paraffins, in quantities e.g., from 0 to 10 wt %, advantageously 0.1 to 4 wt %, by preference 0.2 to 2 wt %, in particular 1 to 3 wt %,
enzymes, e.g., proteases, amylases, cellulases, lipases, in quantities e.g., from 0 to 3 wt %, advantageously 0.1 to 2 wt %, by preference 0.2 to 1 wt %, in particular 0.3 to 0.8 wt %,
optical brightener, e.g., stilbene derivative, biphenyl derivative, in quantities e.g., from 0 to 1 wt %, advantageously 0.1 to 0.3 wt %, in particular 0.1 to 0.4 wt %,
optionally further fragrances,
water,
optionally soap, in quantities e.g., from 0 to 25 wt %, advantageously 1 to 20 wt %, by preference 2 to 15 wt %, in particular 5 to 10 wt %,
optionally solvents (by preference alcohols), advantageously 0 to 25 wt %, by preference 1 to 20 wt %, in particular 2 to 15 wt %, “wt %” being based in each case on the total agent.

A particularly preferred liquid washing or cleaning agent contains, besides the perfume compositions according to the present invention, at least anionic surfactants in quantities from 0.5 wt % to 20 wt %, nonionic surfactants in quantities from 1 wt % to 25 wt %, builders in quantities from 1 to 25 wt %, enzymes, and water.

A further preferred washing or cleaning agent according to the present invention is a liquid fabric softener that by preference can contain, besides the perfume compositions according to the present invention, components that are selected from the following:
cationic surfactants such as especially esterquats, e.g., in quantities from 5 to 30 wt %,
cosurfactants such as, for example, glycerol monostearate, stearic acid, fatty alcohols, and/or fatty alcohol ethoxylates, e.g., in quantities from 0 to 5 wt %, by preference 0.1 to 4 wt %,
emulsifiers such as, for example, fatty amine ethoxylates, e.g., in quantities from 0 to 4 wt %, by preference 0.1 to 3 wt %,
optionally further fragrances,
optionally dyes, by preference in the parts per millions (ppm) range,
solvents such as, in particular, water, e.g., in quantities from 60 to 90 wt %,
   “wt %” being based in each case on the total agent.

### EXAMPLES

In a Miele® model Softronic W1734 washing machine, in the context of washing experiments at 40° C., terrycloth towels (total weight in each case 3.5 kg) made of cotton were washed (water hardness 16° d), spun dry (spin speed 1200 rpm), and then line-dried. The washing experiments were performed mutually independently (a) using 40 g in each case of a bleaching-agent-containing Megaperls® solid universal washing agent (highly compressed solid washing agent obtained via extrusion methods), and (b) using 75 ml in each case of a liquid universal washing agent.

The bleaching-agent-containing solid universal washing agent contained in total 0.4 wt % perfume oil. The perfume oil contained, in variant a1) 10 wt % octanal, in variant a2) 10 wt % of a mixture of octanal and a corresponding oxazolidine (1-aza-3,7-dioxa-2,8-diheptylbicyclo[3.3.0]octane), in variant a3) 10 wt % 1-aza-3,7-dioxa-2,8-diheptylbicyclo[3.3.0]octane, “wt %” being based in each case on the perfume oil. The specific octanal-oxazolidine mixture in accordance with variant a2) encompassed 30 wt % octanal and 70 wt % oxazolidine, based on the octanal-oxazolidine mixture.

The liquid universal washing agent contained in total 1.3 wt % perfume oil. The perfume oil contained, in variant b1) 10 wt % octanal, in variant b2) 10 wt % of a mixture of octanal and a corresponding oxazolidine (1-aza-3,7-dioxa-2,8-diheptylbicyclo[3.3.0]octane), in variant b3) 10 wt % 1-aza-3,7-dioxa-2,8-diheptylbicyclo[3.3.0]octane, “wt %” being based in each case on the perfume oil. The specific octanal-oxazolidine mixture in accordance with variant b2) encompassed 30 wt % octanal and 70 wt % oxazolidine, based on the octanal-oxazolidine mixture.

The product odor (i.e. the odor of the washing agent), the odor of the dried laundry (i.e. one day after laundering), and the odor of the dried laundry after 7 days (i.e. 7 days after laundering) were tested in each case. For storage, the towels were folded and respectively stacked on an open shelf.

The intensity of the odor was graded in each case on a scale from 1 to 5, where 5 is the maximum value and describes a very intense odor, and 1 is the minimum value that describes a still-perceptible odor. The grading was performed by 10 persons trained in perfumery. Each grading was repeated four times, and the average value was then determined.

(a) Evaluation of Solid Universal Washing Agent

The product odor of the agent according to variant a1) (perfume oil containing octanal) was graded with an average score of 3.5. The product odor of the agent according to variant a2) (perfume oil containing octanal and corresponding oxazolidine) was graded with an average score of 4.5. The product odor of the agent according to variant a3) (perfume oil containing oxazolidine) was graded with an average score of 3.

The dried laundry washed with an agent according to variant a1) was graded with an average score of 3. The dried laundry washed with an agent according to variant a2) was graded with an average score of 5. The dried laundry washed with an agent according to variant a3) was graded with an average score of 4.5.

The dried laundry washed with an agent according to variant a1) was graded after 7 days of storage with an average score of 2. The dried laundry washed with an agent according to variant a2) was graded after 7 days of storage with an average score of 5. The dried laundry washed with an agent according to variant a3) was graded with an average score of 4.5.

Use of the mixture according to the present invention in the solid universal washing agent, in accordance with variant a2), accordingly yielded pleasant odor advantages both in the context of the washing agent as such, and in the context of the dried laundry and the dried laundry stored for 7 days.

(b) Evaluation of Liquid Universal Washing Agent

The product odor of the agent according to variant b1) (perfume oil containing octanal) was graded with an average score of 4. The product odor of the agent according to variant b2) (perfume oil containing octanal and corresponding oxazolidine) was graded with an average score of 4.5. The product odor of the agent according to variant b3) (perfume oil containing oxazolidine) was graded with an average score of 3.5.

The dried laundry washed with an agent according to variant b1) was graded with an average score of 3. The dried laundry washed with an agent according to variant b2) was graded with an average score of 4. The dried laundry washed with an agent according to variant b3) was graded with an average score of 3.

The dried laundry washed with an agent according to variant b1) was graded after 7 days of storage with an average score of 1.5. The dried laundry washed with an agent according to variant b2) was graded after 7 days of storage with an average score of 3.5. The dried laundry washed with an agent according to variant b3) was graded with an average score of 3.

Use of the mixture according to the present invention in the liquid universal washing agent, in accordance with variant b2), accordingly yielded pleasant odor advantages both in the context of the washing agent as such, and in the context of the dried laundry and the dried laundry stored for 7 days.

Analogous washing experiments using corresponding softeners yielded comparable results that indicated the advantageousness of the mixtures according to the present invention in terms of product odor and the scent of the dried laundry.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A perfume composition, comprising:
(a) at least one fragrance aldehyde having at least 6 carbon atoms or a fragrance ketone having at least 6 carbon atoms, and
(b) at least one oxazolidine fragrance precursor, corresponding to the fragrance aldehyde or fragrance ketone recited under (a), that can release the same fragrance aldehyde or the same fragrance ketone,
where the oxazolidine fragrance precursor is a 1-aza-3,7-dioxabicyclo[3.3.0]octane compound of the general formula (I) 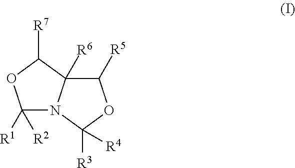
where
R¹, R², R³, R⁴ mutually independently denote residues that, in a compound having the general formula R¹—C(═O)—R² or R³—C(═)—R⁴, yield a fragrance aldehyde having at least 6 carbon atoms or a fragrance ketone having at least 6 carbon atoms, and
R⁵, R⁶, R⁷ mutually independently denote hydrogen or a hydrocarbon residue that can be acyclic or cyclic, substituted or unsubstituted, branched or unbranched, and saturated or unsaturated.

2. The composition of claim 1, wherein the fragrance aldehyde is selected from adoxal (2,6,10-trimethyl-9-undecenal), anisaldehyde (4-methoxybenzaldehyde), cymal (3-(4-isopropylphenyl)-2-methylpropanal), ethylvanillin, florhydral (3-(3-isopropylphenyl)butanal], helional (3-(3,4-methylenedioxyphenyl)-2-methylpropanal), heliotropin, hydroxycitronellal, lauraldehyde, lyral (3- and 4-(4-hydroxy-4-methylpentyl)-3-cyclohexene-1-carboxaldehyde), methylnonylacetaldehyde, lilial (3-(4-tert-butylphenyl)-2-methylpropanal), phenylacetaldehyde, undecylenaldehyde, vanillin, 2,6,10-trimethyl-9-undecenal, 3-dodecen-1-al, alpha-n-amylcinnamaldehyde, melonal (2,6-dimethyl-5-heptenal), 2,4-dimethyl-3-cyclohexene-1-carboxaldehyde (triplal), 4-methoxybenzaldehyde, benzaldehyde, 3-(4-tert-butylphenyl)propanal, 2-methyl-3-(para-methoxyphenyl)propanal, 2-methyl-4-(2,6,6-trimethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl)propanal, 1-decanal, 2,6-dimethyl-5-heptenal, 4-(tricyclo[5.2.1.0(2,6)]-decylidene-8)-butanal, octahydro-4,7-methane-1H-indenecarboxaldehyde, 3-ethoxy-4-hydroxybenzaldehyde, para-ethyl-alpha,alpha-dimethylhydrocinnamaldehyde, alpha-methyl-3,4-(methylenedioxy)hydrocinnamaldehyde, 3,4-methylenedioxybenzaldehyde, alpha-n-hexylcinnamaldehyde, m-cymene-7-carboxaldehyde, alpha-methylphenylacetaldehyde, 7-hydroxy-3,7-dimethyloctanal, undecenal, 2,4,6-trimethyl-3-cyclohexene-1-carboxaldehyde, 4-(3)(4-methyl-3-pentenyl)-3-cyclohexenecarboxaldehyde, 1-dodecanal, 2,4-dimethylcycl hexene-3-carboxaldehyde, 4-(4-hydroxy-4-methylpentyl)-3-cylohexene-1-carboxaldehyde, 7-methoxy-3,7-dimethyloctan-1-al, 2-methylundecanal, 2-methyldecanal, 1-nonanal, 1-octanal, 2,6,10-trimethyl-5,9-undecadienal, 2-methyl-3-(4-tert-butyppropanal, dihydrocinnamaldehyde, 1-methyl-4-(4-methyl-3-pentenyl)-3-cyclohexene-1-carboxaldehyde, 5- or 6-methoxyhexahydro-4,7-methaneindane-1- or -2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3,7-dimethyloctanal, trans-4-decenal, 2,6-nonadienal, para-tolylacetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexenecarboxaldehyde, 3,7-dimethyl-2-methylene-6-octenal, phenoxyacetaldehyde, 5,9-dimethyl-4,8-decadienal, peony aldehyde (6,10-dimethyl-3-oxa-5,9-undecadien-1-al), hexahydro-4,7-methane indane-1-carboxaldehyde, 2-methyloctanal, alpha-methyl-4-(1-methylethyl)benzeneacetaldehyde, 6,6-dimethyl-2-norpinene-2-propionaldehyde, para-methylphenoxyacetaldehyde, 2-methyl-3-phenyl-2-propen-1-al, 3,5,5-trimethylhexanal, hexahydro-8,8 -dimethyl-2-naphthaldehyde, 3-propylbicyclo[2.2.1]-hept-5-ene-2-carbaldehyde, 9-decenal, 3-methyl-5-phenyl-1-pentanal, methylnonylacetaldehyde, hexanal, and trans-2-hexenal.

3. The composition of claim 1, wherein the fragrance ketone is selected from methyl beta-naphthyl ketone, musk indanone (1,2,3,5,6,7-hexahydro-1,1,2,3,3-pentamethyl-4H-inden-4-one), tonalid (6-acetyl-1,1,2,4,4,7-hexamethyltetraline), alpha-damascone, beta-damascone, delta-damascone, isodamascone, damascenone, methyldihydrojasmonate, menthone, carvone, camphor, koavone (3,4,5,6,6-pentamethylhept-3-en-2-one), fenchone, alpha-ionone, beta-ionone, gamma-methyl-ionone, fleuramone (2-heptylcyclopentanone), dihydrojasmone, cis-jasmone, iso-E-Super (1-(1,2,3,4,5,6,7,8-octahydro-2,3,8,8-tetramethyl-2-naphthalenyl)ethan-1-one (and isomers)), methyl cedrenyl ketone, acetophenone, methylacetophenone, para-methoxyacetophenone, methyl beta-naphthyl ketone, benzylacetone, benzophenone, para-hydroxyphenylbutanone, celery ketone (3-methyl-5-propyl-2-cyclohexenone), 6-isopropyldecahydro-2-naphtone, dimethyloctenone, fresco menthe (2-butan-2-ylcyclohexan-1-one), 4-(1-ethoxyvinyl)-3,3,5,5-tetramethylcyclohexanone, methylheptenone, 2-(2-(4-methyl-3-cyclohexen-1-yl)propyl)cyclopentanone, 1-(p-menthen-6(2)yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4(5H)indanone, 4-damascol, dulcinyl (4-(1,3-benzodioxol-5-yl)butan-2-one), hexalone (1-(2,6,6-trimethyl-2-cyclohexen-1-yl)-1,6-heptadien-3-one), isocyclemone E (2-acetonaphthone-1,2,3,4,5,6,7,8-octahydro-2,3,8,8-tetramethyl), methyl nonyl ketone, methylcyclocitrone, methyl lavender ketone, orivone (4-tert-amylcyclohexanone), 4-tert-butylcyclohexanone, delphone (2-pentylcyclopentanone), muscone (CAS 541-91-3), neobutenone (1-(5,5-dimethyl-1-cyclohexenyl)pent-4-en-1-one), plicatone (CAS 41724-19-0), veloutone (2,2,5-trimethyl-5-pentylcyclopentan-1-one), 2,4,4,7-tetramethyloct-6-en-3-one, and tetrameran (6,10-dimethylundecen-2-one).

4. The composition of claim 1, wherein the residues R², R⁴, R⁵, R⁷ each denote hydrogen and the residue R⁶ denotes a methyl, ethyl, or hydroxymethyl residue or hydrogen; and the residues R¹ and R³, mutually independently, each denote a C₆-₂₄ hydrocarbon residue, by preference a C₇₋₂₄ hydrocarbon residue, where the hydrocarbon residue can be acyclic or cyclic, substituted or unsubstituted, branched or unbranched, and saturated or unsaturated.

5. The composition of claim 1, wherein the molar ratio of fragrance aldehyde and/or fragrance ketone to the corresponding oxazolidine fragrance precursor is 20:1 to 1:20.

6. The composition of claim 5, wherein the molar ratio is 10:1 to 1:10.

7. The composition of claim 1, comprising additional fragrances.

8. The composition of claim 1, wherein components (a) and (b) are contained in quantities from 0.1 to 99 wt %, based on the total composition.

9. The composition of claim 8, wherein the quantities are 1 to 50 wt %, based on the total composition.

10. A perfumed consumer product, in particular a washing or cleaning agent, cosmetic agent, room scenting agent, or adhesives, comprising a composition according to claim 1.

11. A washing or cleaning agent comprising a composition according to claim 1 in quantities from 0.0001 to 15 wt %, based on the total agent.

12. A method for scenting textiles, comprising:
subjecting the textiles to a washing process utilizing a composition comprising (a) at least one fragrance aldehyde having at least 6 carbon atoms or a fragrance ketone having at least 6 carbon atoms, and (b) at least one oxazolidine fragrance precursor, corresponding to the fragrance aldehyde or fragrance ketone recited under (a), that can release the same fragrance aldehyde or the same fragrance ketone,
where the oxazolidine fragrance precursor is a 1-aza-3,7-dioxabicyclo[3.3.0]octane compound of the general formula (I) 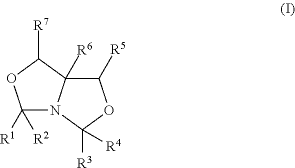
where
R¹, R², R³, R⁴ mutually independently denote residues that, in a compound having the general formula R¹—C(═O)—R² or R³—C(═)—R⁴, yield a fragrance aldehyde having at least 6 carbon atoms or a fragrance ketone having at least 6 carbon atoms, and
R⁵, R⁶, R⁷ mutually independently denote hydrogen or a hydrocarbon residue that can be acyclic or cyclic, substituted or unsubstituted, branched or unbranched, and saturated or unsaturated.

13. A method for scenting textiles, comprising:
subjecting the textiles to a washing process utilizing a washing or cleaning agent comprising (a) at least one fragrance aldehyde having at least 6 carbon atoms or a fragrance ketone having at least 6 carbon atoms, and (b) at least one oxazolidine fragrance precursor, corresponding to the fragrance aldehyde or fragrance ketone recited under (a), that can release the same fragrance aldehyde or the same fragrance ketone,
where the oxazolidine fragrance precursor is a 1-aza-3,7-dioxabicyclo[3.3.0]octane compound of the general formula (I) 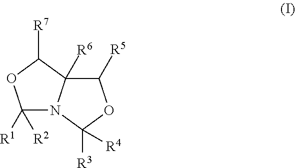
where
R¹, R², R³, R⁴ mutually independently denote residues that, in a compound having the general formula R¹—C(═O)—R² or R³—C(═)—R⁴, yield a fragrance aldehyde having at least 6 carbon atoms or a fragrance ketone having at least 6 carbon atoms, and
R⁵, R⁶, R⁷ mutually independently denote hydrogen or a hydrocarbon residue that can be acyclic or cyclic, substituted or unsubstituted, branched or unbranched, and saturated or unsaturated, and
wherein the composition is present in quantities from 0.0001 to 15 wt %, based on the total agent.
